(19) United States
(12) Patent Application Publication
(10) Pub. No.: US 2004/0068400 A1
(43) Pub. Date: Apr. 8, 2004

(54) Portable communication device adapted to transfer data from an application subsystem to a communication subusstem across a channel and method therefor

(76) Inventor: Vivek G. Gupta, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/264,819

(22) Filed: Oct. 3, 2002

(51) Int. Cl. G10L 19/00

(52) U.S. Cl. 704/201

(57) ABSTRACT

Briefly, in accordance with one embodiment of the invention, a portable communication device that is adapted to transfer user data from an application subsystem to a communication subsystem with a bounded latency.

### BACKGROUND

Conventional portable communication devices such as, for example, cellular telephones may use a vocoder to process voice data. Such cellular telephones are required to transmit voice and audio data to its respective base station(s) within fixed time periods in order to maintain its communication link. Due to the timing constraints and the level of complexity of conventional vocoders, there is little, if any, time to perform processing on the audio data. For example, there may not be enough time to perform mixing, encryption, error code correction, compression, etc. on the audio data.

Thus, there is a continuing need for better ways to process audio data within portable communication devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a portable communication device in accordance with an embodiment of the present invention; and

FIG. 2 is a flow chart diagram of a method in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

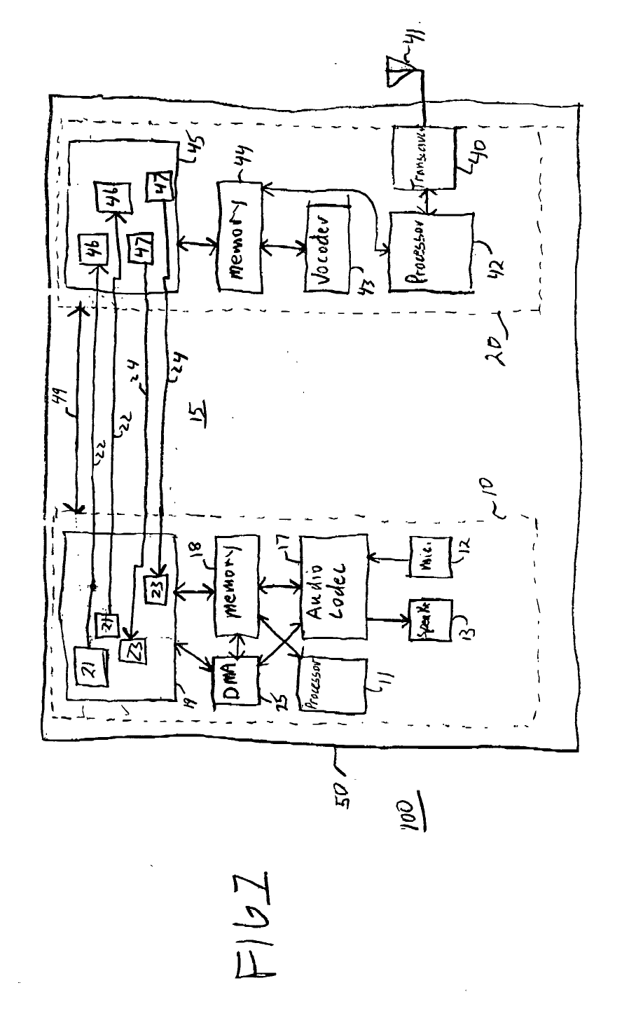

Turning to FIG. 1, an embodiment 100 in accordance with the present invention is described. Embodiment 100 may comprise a portable communication device 50 such as a mobile communication device (e.g., cell phone), a two-way radio communication system, a one-way pager, a two-way pager, a personal communication system (PCS), a portable computer, or the like. Although it should be understood that the scope and application of the present invention is in no way limited to these examples.

In this particular embodiment portable communication device 50 may be a cellular telephone that may communication using a variety of communication protocols. Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

Although the scope of the present invention is not limited in this respect, portable communication device 50 may include an application subsystem 10 and a communication subsystem 20 that communicate with each other over an interface link 15. Simply stated, in this particular embodiment, application subsystem 10 may refer to the portion of portable communication device 50 that is associated with user features or the portion associated with implementation of user applications (e.g. email, calendaring, music, graphics, games, etc.). Although it should be understood that the scope of the present invention is not limited in this respect.

Application subsystem 10 may include a processor 11 such as, for example, a microprocessor, a central processing unit (CPU), a digital signal processor, a microcontroller, a reduced instruction set computer (RISC), a complex instruction set computer (CISC), or the like. Processor 11 may be used to perform a variety of operations, including, but not limited to, the processing of audio data as explained below. Application subsystem 10 may also include a microphone 12 and a speaker 13 that may be used to collect or provide audio signals to a user. The audio signals collected by microphone 12 may be provided to an audio coder/decoder (codec) 17.

Although the scope of the present invention is not limited in this respect, audio codec 17 may include digital-to-analog (D/A) converters, analog-to-digital (A/D) converters, filters, samplers, memory, and/or other components. Audio codec 17 may be used to collect analog audio signals, convert them to digital, and provide them to application subsystem 10 so that they may be used or further processed by other components in portable communication device 50. For example, although the scope of the present invention is not limited in this respect, audio codec 17 may provide the digitized audio data to a system memory 18 that may comprise any combination of any of the memory types described above.

Application subsystem 10 may also comprise a storage device 19 that may be used to store information to be transferred to or received from communication subsystem 20 via interface link 15. For example, storage device 19 may comprise memories 21 that are directly connected to one of channels 22, and may comprise memories 23 that are directly connected to one of channels 24. In such an arrangement, memories 21 may be used to store information that is to be transferred to communication subsystem 20 over interface link 15. Memories 23 may be used to store information that has been received from communication subsystem 20 over interface link 15, although the scope of the present invention is not limited in this respect.

In this particular embodiment, memories 21 and 23 may be first-in-first-out (FIFO) storage devices. For example, Memories 21 and 23 may be implemented as queues that transmit or receive information in the order in which it was received. However, in alternative embodiments, storage device 19 may include other queuing storage devices or employ a prioritization technique to transmit data over interface link 15. For example, an interrupt or prioritization flag technique may be used to indicate the order that the packets in memories 21 and 23 are to be transmitted or the order in which they were received.

In this particular embodiment, storage device 19 may comprise multiple memories or comprise segmented portions of a memory array that are dedicated to particular channels 22, 24 of interface link 15. In other words, storage device 19 may comprise a large memory array that is partitioned suitably with the individual partitions providing memories 21 and 23. However, it should also be understood that the scope of the present invention is not limited by the size or number of memories 21, 23 in storage device 20. Further, in alternative embodiments, memories 21 and 23 may not be contiguous with each other and/or by physically separated from each other. In addition, memories 21 and 23 may optionally comprise other elements or features such as latches, control registers, clocking circuitry, etc. that may be desirable to facilitate the transfer of data across interface link 15.

Lastly, in this particular embodiment, application subsystem 10 may include a direct memory access (DMA) controller 25 that may be used to transfer data within application subsystem 10. Although the scope of the present invention is not limited in this respect, DMA controller 25 may be coupled to storage device 10, system memory 18, audio codec 17, and/or processor 11 as indicated with arrows in FIG. 1. As will be explained in more detail below, DMA controller 25 may be used to facilitate the transfer of data, such as audio data, within application subsystem 10 by moving the audio data from one portion of application subsystem 10 without the use of processor 11, although the scope of the present invention is not limited in this respect.

In this particular embodiment, communication subsystem 20 may refer to the portion of portable communication device 50 that performs wireless communication with other devices (e.g. base stations, access points, other portable devices, etc.). For example, communication subsystem may include a transceiver 40 and an antenna 41 to transmit and/or receive wireless communication signals using any one or more of the communication protocols listed above. A processor 42 such as, for example, a base band processor, a microprocessor, a central processing unit (CPU), a digital signal processor, a microcontroller, a reduced instruction set computer (RISC), a complex instruction set computer (CISC), or the like, may be used to perform operations to control the wireless communication from communication subsystem 20, although the scope of the present invention is not limited in this respect.

Communication subsystem 20 may also include a vocoder 43 that may be used to process the audio and/or voice data signals that have been received or are to be transmitted. The audio and/or voice signals may be stored in a system memory 44 that may comprise any combination of the memory types described above. Lastly, in this particular embodiment, communication subsystem 20 may include a storage device 45 that may be used to store the data that been received from or is to be transferred to application subsystem 10.

Although the scope of the present invention is not limited in this respect, storage device 45 may be similar to storage device 19 and may comprise memories 46 that are directly connected to one of channels 22, and may comprise memories 47 that are directly connected to one of channels 24. In such an arrangement, memories 46 may be used to store information that is to be transferred to communication subsystem 20 over interface link 15. Memories 47 may be used to store information that is to be transferred to application subsystem 10 over interface link 15, although the scope of the present invention is not limited in this respect.

As described above, interface link 15 may provide a link between application subsystem 10 and communication subsystem 20 so that they may share information during the operation of portable communication device 50, although the scope of the present invention is not limited in this respect. Interface link 15 may comprise a variety of signal lines used to facilitate the transfer of information. For example, interface link 15 may include handshaking signal lines 49 that may be used to coordinate communications between application subsystem 10 and communication subsystem 20. Although the scope of the present invention is not limited in this respect, handshaking lines 10 may include clock signal lines to synchronize transfers, priority or interrupt lines to determine when transfers occur, signals to provide security or control the flow of information, etc.

As mentioned above, interface link 15 may also include channels 22, 24 to transfer data between application subsystem 10 and communication subsystem 20. Channels 22, 24 may comprise any combination of serial and parallel data lines to transfer packets. Channels 22, 24 may also optionally have other signals lines to perform handshaking operations to facilitate data transfers, although the scope of the present invention is not limited in this respect.

As will be explained below, in some particular embodiments, although not necessarily all, audio packets may be transferred between application subsystem 10 and communication subsystem 20 without the use of headers. This may be accomplished by dedicating one of more of channels 22, 24 to be used for the transfer. By eliminating the use of headers it may be possible to avoid or reduce the use of software to facilitate the transfer of data between application subsystem 10 and communication subsystem 20. This, in turn, may provide for the transferring of data between the application subsystem 10 and communication subsystem 20 within a bounded latency (e.g. a predictable or predetermined time period), although the scope of the present invention is not limited in this respect.

In alternative embodiments, data packets may be transferred involving the use of software interaction or the use of headers in the packets. It should also be understood that the scope of the present invention is not limited to applications involving the transfer of audio files. In alternative embodiments other user data may be transferred such as data related to music, video, or other applications being executed on application subsystem 10. Further, data from peripheral devices (e.g. universal serial bus devices, etc.) that are coupled to portable communication device may be transferred. It may also be desirable to transfer data or information associated with the operating systems being executed by application subsystem 10, communication subsystem 20, or both.

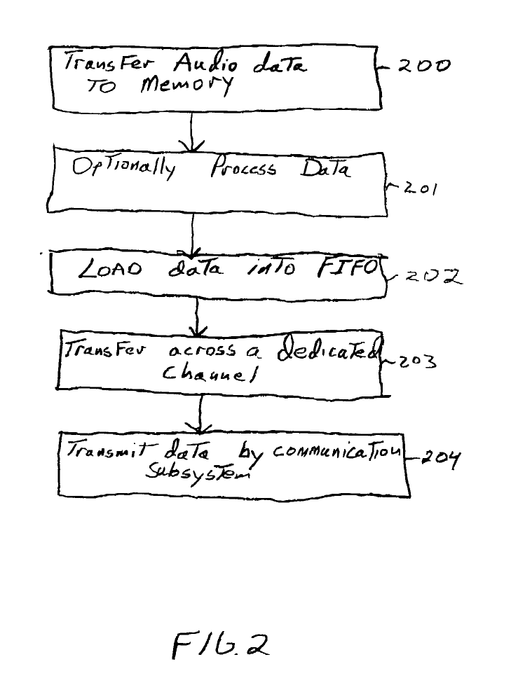

Turning now to FIG. 2, a method in accordance with a particular embodiment is described. Although the scope of the present invention is not limited in this respect, microphone 12 may be used to capture a sample of an audio signal. The audio signal may be converted to a digital representation by audio codec 17. It should be understood that the scope of the present invention is not limited by the type of data that is captured or the process by which the sample is converted to a digital representation as any may be used as desired. Audio codec 17 may then transfer a digital form of the audio data to memory 18, box 200. It should also be understood that the audio data may come from other sources (e.g. a peripheral) and need not be limited to music data. In alternative embodiments the data may represent voice, video, or other user data as suggested above.

While the audio data is in memory 18, it may be desirable to have processor 11 perform some type of processing on the digital audio data, box 201. For example, processor 11 may optionally be used to perform encryption, decoding, encoding, mixing, error code correction, compression, etc. on the data. In addition, processor 11 may be used to mix the audio data with other information. It should be understood, however, that processing by processor 11 is considered optional and not a limitation upon the scope of the present invention.

The process of transferring the audio data from audio codec 17 in application subsystem 10 may include transferring the data from memory 18 into storage device 19 so that it may be transferred to communication subsystem 20 across a dedicated channel 22, box 202. In one particular embodiment, the audio data may be transferred directly from audio codec 17 to one of memories 21 through a direct connection initiated by audio codec 17 or perhaps processor 11. In another embodiment, the audio data may be transferred from audio codec 17 to memory 18 and then to one of memories 21.

Alternatively, DMA controller may move the audio data directly from audio codec 17 to one of memories 19. In yet another embodiment, DMA controller may move the audio data from audio codec 17, to memory 18, and then to storage device 19. Further, DMA controller 25 may optionally move the data through other components before moving the audio data to storage device 19. The use of DMA controller 25 should be considered optional and may be desirable so that such a transfer may be done without imposing any additional burden upon processor 11.

In other embodiments, the audio data may come from other sources such as peripheral devices or processor 11. Again, it should also be understood that the scope of the present invention is not limited to the transfer of audio data as other types of user, application, or operating system data may be transferred. As a result, the data to be transferred may come from a variety of sources within application subsystem 10.

The audio data may then be transferred from application subsystem 10 to communication subsystem 20 via a dedicated channel 22, box 203. Although the scope of the present invention is not limited in this respect, the audio data may be transferred across one of channels 22 such that both application subsystem 10 and communication subsystem 20 recognize that the particular channel being used is dedicated to transferring audio data. As a result, the transfer may be performed without the need for the overhead associated with software instructions that would otherwise be used to inform storage devices 19 and 45 of the nature of the information being transferred.

In some embodiments, although the scope of the present invention is not limited in this respect, the audio data may be transferred across a dedicated channel 22 without the use of a header. Since both storage device 19 and storage device 45 may recognize the data being transferred as audio data, the transfer may be accomplished without the need to add a header indicating the type of data being transferred, the priority to be associated with the transfer, or the destination of the data being transferred.

Although the scope of the present invention is not limited in this respect, audio data may be transferred from application subsystem 10 to communication subsystem 20 without the use of any software intervention or minimal intervention. Thus, in particular embodiments, although not necessarily all, data may be transferred from application subsystem 10 to communication subsystem 20 within a bounded latency. Since the transfer may be facilitated using all or mostly hardware that may have a predictable transfer rate, the data may be transferred within a predictable time period.

Transferring audio or other data within a bounded latency may be desirable so that the data may be transferred to communication subsystem 20 in a timely manner so portable communication device 50 may transmit the data in accordance with any time constraints associated with the particular communication protocol being used by portable communication device 50. For example, if portable communication device 50 has to transmit the audio data during a time slot approximately every 20 milliseconds, application subsystem 10 may transfer the data to communication subsystem 20 in less time, although the scope of the present invention is not limited in this respect. For example, application subsystem 10 may transfer the data within a bounded latency of about 500 nanoseconds or less from the time the data is actually available for transfer.

The audio data may therefore be transferred from memory 21 of storage device 19 across a dedicated channel 22 and received by a memory 46 in communication subsystem 20. The audio data, or other data, may then be transferred to memory 44 in communication subsystem 20. The data may then optionally be processed by either vocoder 43 or processor 42 to prepare the data for transmission. The data may then be transmitted by transceiver 40, step 204.

It should be understood that the scope of the present invention is not limited to just transferring audio or user data from an application subsystem to a communication subsystem within a bounded latency time period. A similar technique may be used to transfer data from communication subsystem 20 to application subsystem 10 using a similar technique by reversing the process described above. Although the scope of the present invention is not limited in this respect, such a process may involve the transfer of data without or without the use of software intervention, with or without the use of a dedicated channel, and with or without the use of headers in the data files/packets. Further, the transfer may be performed within a bounded latency time period if desired.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of transferring data within a portable communication device comprising transferring audio data from an audio codec in an application subsystem across a channel to a communication subsystem.

2. The method of claim 1 further comprising transferring the audio data from the audio codec to a system memory.

3. The method of claim 1, wherein transferring audio data includes transferring audio data from the application system to the communication subsystem with a bounded latency.

4. The method of claim 1, wherein transferring audio data includes transferring with a bounded latency of less than about 500 nanoseconds.

5. The method of claim 1, further including transferring the audio data from the audio codec to a storage device in the application subsystem coupled to an outbound channel.

6. The method of claim 5, further including transferring the audio data from the audio codec to a first-in-first-out (FIFO) storage device in the application subsystem.

7. The method of claim 1, further including transferring audio data from the audio codec with a direct memory access (DMA).

8. The method of claim 2, further comprising processing the audio data stored in the system memory with a processor.

9. The method of claim 8, wherein processing the audio data includes encrypting the audio data with the processor.

10. The method of claim 1, wherein transferring the audio data includes transferring the audio data across a channel without a header in the audio data.

11. The method of claim 1, wherein transferring the audio data includes transferring the audio data across a dedicated channel.

12. A method of transferring user data from an application subsystem of a portable computing device to a communication subsystem comprising transferring the user data across a channel with a bounded latency.

13. The method of claim 12, wherein transferring the user data includes transferring the user data without a header.

14. The method of claim 12, wherein transferring the user data includes transferring the user data across a dedicated channel.

15. The method of claim 12, wherein transferring the user data includes transferring the user data from a first-in-first-out (FIFO) in the application subsystem to a FIFO in the communication subsystem via the channel.

16. The method of claim 12, wherein transferring the user data includes transferring the user data across a channel comprising parallel data lines.

17. The method of claim 12, further comprising transferring the user data from an audio codec to system memory.

18. The method of claim 12, further comprising transferring user data from a peripheral coupled to the application subsystem.

19. A portable communication device comprising:
an application subsystem having an audio codec; and
a communication subsystem, wherein the portable communication device is adapted to transfer an audio data from the application subsystem to the communication subsystem across a dedicated channel.

20. The portable communication device of claim 19, wherein the dedicated channel includes a parallel data bus.

21. The portable communication device of claim 19, wherein the application subsystem includes a first-in-first-out (FIFO) coupled to the dedicated channel.

22. The portable communication device of claim 21, further comprising a direct memory access (DMA) controller to transfer the audio data to the FIFO.

23. The portable communication device of claim 19, wherein the portable communication device is adapted to transfer the audio data within a bounded latency.

24. The portable communication device of claim 19, wherein the portable communication device is adapted to transfer the audio data without the use of a header.

25. The portable communication device of claim 19, further comprising another dedicated channel to transfer data from the communication subsystem to the application subsystem.

26. An article comprising a storage medium having stored thereon instructions, that, when executed by a computing platform, results in:
transferring user data from an application subsystem of a portable device to a communication subsystem across a channel with a bounded latency.

27. The article of claim 26, wherein the instructions, when executed, further results in transferring the user data without a header.

28. The article of claim 26, wherein the instructions, when executed, further results in transferring the user data across a dedicated channel.

29. The article of claim 26, wherein the instructions, when executed, further results in transferring the user data from a first-in-first-out (FIFO) in the application subsystem to a FIFO in the communication subsystem via the channel.

30. The article of claim 26, wherein the instructions, when executed, further results in transferring the user data across a channel comprising parallel data lines.
